(19) United States
(12) Patent Application Publication
(10) Pub. No.: US 2025/0102942 A1
(43) Pub. Date: Mar. 27, 2025

(54) ELECTROSTATIC IMAGE DEVELOPING TONER SET, ELECTROSTATIC IMAGE DEVELOPER SET, TONER CARTRIDGE SET, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yukiaki NAKAMURA, Kanagawa (JP); Kohei MANABE, Kanagawa (JP); Misaki HORIUCHI, Kanagawa (JP)

(73) Assignee: FUJIFILM Business Innovation Corp., Tokyo (JP)

(21) Appl. No.: 18/646,911

(22) Filed: Apr. 26, 2024

(30) Foreign Application Priority Data
Sep. 26, 2023 (JP) 2023-163846

(51) Int. Cl. G03G 9/09; G03G 9/087; G03G 9/097

(52) U.S. Cl. CPC G03G 9/0906; G03G 9/08755; G03G 9/09725; G03G 2215/0109; G03G 2215/0604; G03G 2215/066; G03G 2221/183

(57) ABSTRACT

An electrostatic image developing toner set includes a yellow toner including a yellow pigment; a magenta toner including a magenta pigment; a cyan toner including a cyan pigment; a black toner including a black pigment; a first toner that is a dye toner or a transparent toner, the first toner having a crystallization temperature T1 of 80° C. or more and 95° C. or less; and a second toner that is a dye toner or a transparent toner, the second toner having a crystallization temperature T2 of 60° C. or more and 75° C. or less.

### CROSS-REFERENCE TO RELATED APPLICATIONS

This application is based on and claims priority under 35 USC 119 from Japanese Patent Application No. 2023-163846 filed Sep. 26, 2023.

### BACKGROUND

### (i) Technical Field

The present disclosure relates to an electrostatic image developing toner set, an electrostatic image developer set, a toner cartridge set, a process cartridge, an image forming apparatus, and an image forming method.

### (ii) Related Art

Japanese Unexamined Patent Application Publication No. 2021-127427 discloses a resin particle set including fluorescent resin particles that include a fluorescent colorant and colored resin particles that include a colored colorant, wherein the fluorescent resin particles have a larger volume average particle size than the colored resin particles and an average circularity of 0.93 or more. It is also disclosed that the fluorescent resin particles and the colored resin particles may be used as components of an electrostatic image developing toner.

Japanese Unexamined Patent Application Publication No. 2019-056905 discloses a toner set for image forming apparatuses, the toner set including a fluorescent toner including a binder resin and a fluorescent agent and a color toner including a binder resin and a colorant, wherein the 60-degree glossiness Gf of a solid image formed using the fluorescent toner is 10 or more and 25 or less and the difference (Gn−Gf) between the 60-degree glossiness Gn of a solid image formed using the color toner and the 60-degree glossiness Gf of the solid image formed using the fluorescent toner is 10 or more and 28 or less.

### SUMMARY

Aspects of non-limiting embodiments of the present disclosure relate to an electrostatic image developing toner set with which a phenomenon in which toner particles become melted to an excessive degree to adhere to a fusing member when a toner image is fixed (hereinafter, this phenomenon is also referred to as “hot offset”) and a phenomenon in which toner particles cannot become melted to a sufficient degree to transfer to a fusing member due to an insufficient amount of heat fed to the toner particles when a toner image is fixed (hereinafter, this phenomenon is also referred to as “cold offset”) may be both reduced, compared with an electrostatic image developing toner set that includes yellow, magenta, cyan, and black toners, a first toner that is a dye toner or a transparent toner, and a second toner that is a dye toner or a transparent toner, wherein the first toner has a crystallization temperature T1 of less than 80° C. or the second toner has a crystallization temperature T2 of more than 75° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing toner set including a yellow toner including a yellow pigment; a magenta toner including a magenta pigment; a cyan toner including a cyan pigment; a black toner including a black pigment; a first toner, the first toner being a dye toner or a transparent toner, the first toner having a crystallization temperature T1 of 80° C. or more and 95° C. or less; and a second toner, the second toner being a dye toner or a transparent toner, the second toner having a crystallization temperature T2 of 60° C. or more and 75° C. or less.

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to an exemplary embodiment of the disclosure; and

FIG. 2 is a schematic diagram illustrating an example of a process cartridge detachably attachable to the image forming apparatus according to an exemplary embodiment of the disclosure.

### DETAILED DESCRIPTION

Exemplary embodiments of the present disclosure are described below. It should be noted that the following description and Examples are illustrative of the exemplary embodiments but not restrictive of the scope of the exemplary embodiments.

In the present disclosure, a numerical range expressed using “to” means the range that includes the values described before and after “to” as the minimum and maximum values, respectively.

In the present disclosure, when numerical ranges are described in a stepwise manner, the upper or lower limit of a numerical range may be replaced with the upper or lower limit of another numerical range, respectively. In the present disclosure, the upper or lower limit of a numerical range may also be replaced with a value described in Examples below.

In the present disclosure, the term “step” refers not only to an individual step but also to a step that is not distinguishable from other steps but achieves the intended purpose of the step.

In the present disclosure, when an exemplary embodiment is described with reference to a drawing, the structure of the exemplary embodiment is not limited to the structure illustrated in the drawing. The sizes of the members illustrated in the attached drawing are conceptual and do not limit the relative relationship among the sizes of the members.

Each of the components described in the present disclosure may include a plurality of types of substances that correspond to the component. In the present disclosure, in the case where a composition includes a plurality of substances that correspond to a component of the composition, the content of the component in the composition is the total content of the substances in the composition unless otherwise specified.

Each of the components described in the present disclosure may include a plurality of types of particles that correspond to the component. In the case where a composition includes a plurality of particles that correspond to a component of the composition, the size of particles of the component is the size of particles of a mixture of the plurality of particles included in the composition unless otherwise specified.

In the present disclosure, the term “(meth) acryl” refers to both “acryl” and “methacryl”, and the term “(meth)acrylate” refers to both “acrylate” and “methacrylate”.

The term “principal component” used in the present disclosure refers to, for example, a component of a mixture including a plurality of types of components the content of which relative to the total mass of the mixture is the highest in terms of mass.

In the present disclosure, “electrostatic image developing toner”, “electrostatic image developing toner set”, “electrostatic image developer”, “electrostatic image developer set”, and “electrostatic image developing carrier” are also referred to as “toner”, “toner set”, “developer”, “developer set”, and “carrier”, respectively.

### Electrostatic Image Developing Toner Set

A toner set according to an exemplary embodiment of the disclosure includes a yellow toner including a yellow pigment, a magenta toner including a magenta pigment, a cyan toner including a cyan pigment, a black toner including a black pigment, a first toner, the first toner being a dye toner or a transparent toner, the first toner having a crystallization temperature T1 of 80° C. or more and 95° C. or less, and a second toner, the second toner being a dye toner or a transparent toner, the second toner having a crystallization temperature T2 of 60° C. or more and 75° C. or less.

In electrophotographic printing, process printing in which yellow (Y), magenta (M), cyan (C), black (K) are used is commonly employed. In process printing, a toner set including yellow, magenta, cyan, and black toners including yellow, magenta, cyan, and black pigments, respectively, is used.

Hereinafter, yellow, magenta, cyan, and black toners are referred to collectively as “YMCK toners”.

It has become popular to view photographs, pictures, illustrations, and the like with a vivid monitor due to the evolution and widespread use of televisions, monitors, tablets, smartphones, and the like. Photographs, illustrations (e.g., illustrations drawn with a PC), and the like viewed with a monitor have bright color tones in addition to a wide color gamut. In order to represent the wide color gamut and bright color tones, there has been attempt to use a toner set that includes YMCK toners and a dye toner including a dye, such as a fluorescent dye, for image formation. A toner set that further includes a transparent toner may also be used in order to, for example, control the glossiness of images or increase the adhesion of images.

The toner set according to this exemplary embodiment includes YMCK toners, a first toner that is a dye toner or a transparent toner, and a second toner that is a dye toner or a transparent toner.

Furthermore, in this exemplary embodiment, the crystallization temperature T1 of the first toner is 80° C. or more and 95° C. or less, and the crystallization temperature T2 of the second toner is 60° C. or more and 75° C. or less. This may reduce the occurrence of hot offset and cold offset. The reasons for this are not clear but considered as described below.

For example, an image can be formed using the toner set including the YMCK toners, the first toner, and the second toner in the following manner. Specifically, first, yellow, magenta, cyan, and black images and first and second images are formed using the yellow, magenta, cyan, and black toners and the first and second toners, respectively. Hereinafter, the yellow, magenta, cyan, and black images are also referred to collectively as “YMCK images”.

The above images are transferred to a recording medium to form a toner image including the six layers of images stacked on top of one another. Subsequently, the toner image including the six layers of images is fixed to the recording medium. In the toner image formed on the recording medium, for example, the first and second images are located farther from the recording medium than the YMCK images.

As described above, an image formation method in which a toner set including the YMCK toners and the first and second toners includes a fixing step in which a toner image including the six layers of images, which are formed using the respective toners and stacked on top of one another, is fixed to a recording medium. This increases the amount of heat required for fixing the toner image to a recording medium and the fusing temperature in the fixing step, compared with the case where an image is formed using a toner set including only YMCK toners.

For example, in the case where both first and second toners have low crystallization temperatures, fixing the toner image including the six layers of images to a recording medium at a high fusing temperature increases the occurrence of hot offset. Specifically, the fusing member applies a load to the toner image while both first and second images, which are stacked on the YMCK images and located on the fusing member-side, have low viscosities and are unlikely to solidify. Since the toner image including the six layers of images is thick, the load applied by the fusing member is increased and, consequently, the molten toner particles are likely to adhere to the fusing member. The occurrence of the hot offset is likely to significantly increase in the case where an image is formed on a thin recording medium, such as a thin paper sheet.

In contrast, in the case where both first and second toners have high crystallization temperatures, the amount of heat fed to the toner image becomes insufficient compared with the amount of heat required for melting the toner image and, consequently, cold offset is likely to occur. The occurrence of the cold offset is likely to significantly increase in the case where an image is formed on a thick recording medium, such as a thick paper sheet.

In this regard, in this exemplary embodiment, the first toner has a crystallization temperature T1 of 80° C. or more and 95° C. or less, and the second toner has a crystallization temperature T2 of 60° C. or more and 75° C. or less. This may reduce the occurrence of hot offset, which is likely to occur when both first and second toners have low crystallization temperatures, compared with the case where the crystallization temperature T1 is less than 80° C. Furthermore, the occurrence of cold offset, which is likely to occur when both first and second toners have high crystallization temperatures, may be reduced compared with the case where the crystallization temperature T2 is more than 75° C. It is considered that, as a result, the occurrence of both hot offset and cold offset may be reduced.

The hot offset is unlikely to occur in the case where an image is formed using a toner set including only the YMCK toners and the second toner. The reasons for this are not clear but considered to be that the second image disposed on the YMCK images is unlikely to detach from the YMCK images due to the adhesion of the YMCK images.

The hot offset is also unlikely to occur in the case where an image is formed using only the second toner. The reasons for this are not clear but considered to be that the second image disposed on a recording medium permeates the recording medium to produce an anchor effect, which makes the image unlikely to detach from the recording medium.

The toner set according to an exemplary embodiment of the disclosure includes at least the YMCK toners, the first toner, and the second toner and may further include a toner other than any of the six types of toners (hereinafter, such a toner is also referred to as “other toner”). Examples of the other toner include a pigment toner other than any of the YMCK toners, that is, a toner including toner particles which include a pigment as a principal colorant component and in which the content of a dye is less than 10% by mass of the total mass of the colorant.

### Crystallization Temperature

The crystallization temperature of a toner is determined by differential scanning calorimetry. Specifically, the toner that is to be analyzed is set to a differential scanning calorimeter “DSC-50” produced by Shimadzu Corporation which is equipped with an auto-tangent processing system, and liquid nitrogen is set to the differential scanning calorimeter as a cooling medium. The toner is heated from 20° C. to 150° C. at a heating rate of 10° C./min in order to determine the relationship between temperature (° C.) and the amount of heat (mW). Subsequently, the toner is cooled to 0° C. at a cooling rate of −10° C./min in order to determine a temperature-drop spectrum. The temperature at which an exothermic peak occurs in the temperature-drop spectrum is considered as the crystallization temperature of the toner. In the case where the temperature-drop spectrum has a plurality of exothermic peaks, the temperature at which the maximum peak occurs is considered as the crystallization temperature.

The crystallization temperature T1 of the first toner is 80° C. or more and 95° C. or less. The crystallization temperature T1 is preferably 80° C. or more and 90° C. or less and is more preferably 85° C. or more and 90° C. or less in order to reduce both hot offset and cold offset.

The crystallization temperature T2 of the second toner is 60° C. or more and 75° C. or less. The crystallization temperature T2 is preferably 60° C. or more and 70° C. or less and is more preferably 65° C. or more and 70° C. or less in order to reduce both hot offset and cold offset.

Examples of a combination of the first toner having a crystallization temperature T1 that falls within the above range and the second toner having a crystallization temperature T2 that falls within the above range include a combination of a first toner including first toner particles including a crystalline resin and a granular material and a second toner including second toner particles including a crystalline resin. The first and second toners may further include a release agent. In other words, the combination of the first toner having a crystallization temperature T1 that falls within the above range and the second toner having a crystallization temperature T2 that falls within the above range may be a combination of a first toner including first toner particles including a crystalline resin, a release agent, and a granular material and a second toner including second toner particles including a crystalline resin and a release agent. It is preferable that the second toner particles substantially do not include a granular material. That is, the content of the granular material in the second toner particles may be less than 1% by mass of the total amount of the second toner particles.

It is considered that, when the first toner particles include a crystalline resin and a granular material, the crystallization of the crystalline resin on the particles of the granular material, which serve as crystal nuclei, is facilitated and, consequently, the crystallization temperature T1 can be controlled to fall within the above range. It is considered that, in particular, when the first toner particles include a crystalline resin, a release agent, and a granular material, the crystallization of the crystalline resin and the release agent on the particles of the granular material, which serve as crystal nuclei, is facilitated and, consequently, the crystallization temperature T1 can be controlled to fall within the above range.

It is considered that, when the second toner particles include a crystalline resin and substantially do not include a granular material, the crystallization temperature T2 can be controlled to fall within the above range because the material that serves as a crystal nucleus is absent and the crystallization of the crystalline resin is not facilitated. It is also considered that, when the second toner particles include a crystalline resin and a release agent and substantially do not include a granular material, the crystallization temperature T2 can be controlled to fall within the above range because the material that serves as a crystal nucleus is absent and the crystallization of the crystalline resin and the release agent is not facilitated.

Details of the crystalline resin and the granular material are described below.

The difference between the crystallization temperatures T1 and T2 is preferably 15° C. or more, is more preferably 20° C. or more, and is further preferably 25° C. or more in order to reduce the occurrence of both hot offset and cold offset. The upper limit for the difference between the crystallization temperatures T1 and T2 is not set and may be, for example, 35° C.

When the difference between the crystallization temperatures T1 and T2 of the toner set is equal to or more than the above lower limit, the crystallization temperature T1 is relatively high and the crystallization temperature T2 is relatively low. This may reduce the occurrence of hot offset compared with the case where both crystallization temperatures T1 and T2 are low and the occurrence of cold offset compared with the case where both crystallization temperatures T1 and T2 are high. As a result, the occurrence of both hot offset and cold offset may be reduced.

A crystallization temperature T3 that is the average of the crystallization temperatures of the yellow, magenta, cyan, and black toners is not limited and is, for example, 80° C. or more and 95° C. or less. The crystallization temperature T3 is preferably 80° C. or more and 90° C. or less and is more preferably 85° C. or more and 90° C. or less.

The difference between the crystallization temperatures T1 and T3 is, for example, 10° C. or less. The above difference is preferably 5° C. or less and is more preferably 3° C. or less in order to reduce the occurrence of both hot offset and cold offset.

The difference between the crystallization temperatures T2 and T3 is, for example, 12° C. or more. The above difference is preferably 20° C. or more and is more preferably 25° C. or more in order to reduce the occurrence of both hot offset and cold offset. The upper limit for the difference between the crystallization temperatures T2 and T3 is not set and is, for example, 35° C.

In order to reduce the occurrence of both hot offset and cold offset, it is preferable that the difference between the crystallization temperatures T1 and T3 be 10° C. or less and the difference between the crystallization temperatures T2 and T3 be 12° C. or more, it is more preferable that the difference between the crystallization temperatures T1 and T3 be 5° C. or less and the difference between the crystallization temperatures T2 and T3 be 20° C. or more, and it is further preferable that the difference between the crystallization temperatures T1 and T3 be 3° C. or less and the difference between the crystallization temperatures T2 and T3 be 25° C. or more.

Details of the toners included in an example of the toner set according to this exemplary embodiment are described below.

### YMCK Toners

The YMCK toners are not limited and may be any yellow, magenta, cyan, and black toners including yellow, magenta, cyan, and black pigments, respectively. Each of the YMCK toners is a toner including toner particles which include a pigment as a principal colorant component and in which the content of a dye is less than 10% by mass of the total mass of the colorant. The YMCK toners may be yellow, magenta, cyan, and black toners known in the art.

The specific structure of the YMCK toners may be, for example, the same as that of the first and second toners described below, except that they include yellow, magenta, cyan, and black pigments as colorants, respectively.

### First and Second Toners

The first and second toners are each any toner which is a dye toner or a transparent toner and the crystallization temperature of which falls within the above range.

The dye toner is a toner that includes a dye. The dye toner includes dye toner particles that are toner particles including a dye. The dye toner particles may include a colorant other than a dye. In the case where the dye toner particles include a colorant other than a dye, the dye toner particles are toner particles in which the content of the dye is 10% by mass or more of the total mass of the colorant. Examples of the dye toner include a fluorescent toner, that is, a toner including toner particles that include a fluorescent dye. Examples of the fluorescent toner include a fluorescent green toner, a fluorescent pink toner, a fluorescent red toner, a fluorescent orange toner, a fluorescent yellow toner, a fluorescent blue toner, and a fluorescent purple toner. The fluorescent toner may be an invisible fluorescent toner that is normally colorless and fluoresces upon being irradiated with an ultraviolet ray.

The transparent toner is a toner that substantially does not include a colorant, that is, a toner in which the content of the colorant is less than 1% by mass of the total amount of the toner.

In this exemplary embodiment, both first and second toners may be dye toners; the first toner may be a dye toner while the second toner is a transparent toner; and the first toner may be a transparent toner while the second toner is a dye toner.

In the case where both first and second toners are dye toners, the first and second toners may be toners having different hues. Examples of the combination of the first and second toners having different hues include a combination of a fluorescent green toner and a fluorescent pink toner, a combination of green and pink toners, a combination of a fluorescent green toner and a fluorescent orange toner, a combination of green and orange toners, and a combination of a fluorescent yellow toner and a fluorescent pink toner.

In the case where both first and second toners are dye toners, the difference between the hue angles of the first and second toners is preferably 120 degrees or more and 180 degrees or less, is more preferably 135 degrees or more and 180 degrees or less, is further preferably 145 degrees or more and 180 degrees or less, and is particularly preferably 160 degrees or more and 180 degrees or less in order to achieve a wide color gamut.

The difference in chroma between the first and second toners is preferably 30 or less, is more preferably 25 or less, and is further preferably 20 or less. The difference in chroma between the first and second toners may be 0 and may be 10 or more.

The difference in lightness between the first and second toners is preferably 20 or less, is more preferably 15 or less, and is further preferably 10 or less. The difference in lightness between the first and second toners may be 0 and may be 3 or more.

The hue angle, chroma, and lightness of a toner are determined by the following method.

The toner that is to be analyzed is charged into “Revoria Press PC1120” produced by FUJIFILM Business Innovation Corp. A solid image (4.0 cm×2.5 cm) is formed on an A4-size sheet of “OS Coat Paper” (127 gsm) used as a recording medium at a toner deposition density of 4.0 g/m² and a fusing temperature of 180° C. using the above apparatus with only the toner that is to be analyzed.

For determining hue angle (h), chroma (C*), and lightness (L*), the solid image formed on the recording medium by the above-described method is subjected to “exact Advanced” (aperture 4 mm) produced by X-Rite, Inc. 10 times randomly. The average color gamut of the solid image is used as color reproduction values (L*, a*, and b*). Lightness (L*) is calculated from the color reproduction values (L*, a*, and b*). Hue angle (h) and chroma (C*) are calculated using the following formulae.

$${Chroma ( {C}^{*} ) = ( {( {a}^{*} )}^{2} + {( {b}^{*} )}^{2} ) )}^{1 / 2} \\ Hue angle ( h ) = {tan}^{- 1} ( {b}^{*} / {a}^{*} )$$

Details of the first and second toners are described below.

The first toner includes first toner particles and, as needed, an external additive.

The second toner includes second toner particles and, as needed, an external additive.

### Toner Particles

The first toner particles and the second toner particles each include, for example, a binder resin and, as needed, a colorant, a release agent, and other additives.

The first toner particles and the second toner particles may include a crystalline resin in order to make it easy to control the crystallization temperatures T1 and T2 to fall within the above ranges. For example, the crystalline resin is included in the toner particles as one of the binder resin components constituting the toner particles. The first toner particles and the second toner particles may include a crystalline resin and a release agent in order to make it easy to control the crystallization temperatures T1 and T2 to fall within the above ranges.

The first toner particles may include a granular material in order to make it easy to control the crystallization temperature T1 to fall within the above range. In the case where the granular material is the pigment described below, the granular material is included in the toner particles as one of the colorant components included in the toner particles as needed. In the case where the granular material is the inorganic particles described below, the granular material is included in the toner particles as one of the other additive components included in the toner particles as needed.

Each of the components of the toner particles is described below.

### Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

As described above, the first toner particles and the second toner particles may include a crystalline resin as a binder resin component.

The first toner particles and the second toner particles may include a crystalline resin and an amorphous resin as binder resins.

The term “crystalline” used herein for resins refers to a property of exhibiting a distinct endothermic peak instead of a step-like endothermic change in DSC, that is, specifically, a property of exhibiting an endothermic peak with a half-width of 10° C. or less at a heating rate of 10° C./min.

The term “amorphous” used herein for resins refers to a property of having a half-width of more than 10° C., a property of exhibiting a step-like endothermic change, or a property of not exhibiting a distinct endothermic peak.

### Crystalline Resin

Examples of the crystalline resin include publicly known crystalline resins, such as a crystalline polyester resin and a crystalline vinyl resin (e.g., a polyalkylene resin or a long-chain alkyl (meth)acrylate resin). Among these, a crystalline polyester resin may be used as a crystalline resin in consideration of the mechanical strength and low-temperature fixability of the toner.

### Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetricarboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-cicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The crystalline polyester resin may have a weight average molecular weight Mw of 6,000 or more and 35,000 or less.

The weight average molecular weight of a resin is determined by gel permeation chromatography (GPC). Specifically, the molecular weights of the resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight of the resin is determined on the basis of the results of the measurement using a molecular-weight calibration curve based on monodisperse polystyrene standard samples.

The crystalline polyester resin may be produced by any suitable method known in the related art similarly to, for example, the amorphous polyester resin, which is described below.

### Melting Temperature of Crystalline Resin

The melting temperature of the crystalline resin included in the first toner particles is preferably 50° C. or more and 100° C. or less, is more preferably 55° C. or more and 90° C. or less, and is further preferably 60° C. or more and 85° C. or less in order to control the crystallization temperature T1 to fall within the above range.

The melting temperature of the crystalline resin included in the second toner particles is preferably 50° C. or more and 100° C. or less, is more preferably 55° C. or more and 90° C. or less, and is further preferably 60° C. or more and 85° C. or less in order to control the crystallization temperature T2 to fall within the above range.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

### Content of Crystalline Resin

The content of the crystalline resin in the first toner particles is preferably 1% by mass or more and 20% by mass or less, is more preferably 3% by mass or more and 15% by mass or less, and is further preferably 6% by mass or more and 10% by mass or less of the total amount of the first toner particles in order to control the crystallization temperature T1 to fall within the above range.

The content of the crystalline resin in the second toner particles is preferably 1% by mass or more and 20% by mass or less, is more preferably 3% by mass or more and 15% by mass or less, and is further preferably 6% by mass or more and 10% by mass or less of the total amount of the second toner particles in order to control the crystallization temperature T2 to fall within the above range.

The content of the crystalline resin in the first toner particles is preferably 2% by mass or more and 40% by mass or less, is more preferably 2% by mass or more and 20% by mass or less, and is further preferably 5% by mass or more and 15% by mass or less of the total amount of all the binder resins included in the first toner particles in order to control the crystallization temperature T1 to fall within the above range.

The content of the crystalline resin in the second toner particles is preferably 2% by mass or more and 40% by mass or less, is more preferably 2% by mass or more and 20% by mass or less, and is further preferably 5% by mass or more and 15% by mass or less of the total amount of all the binder resins included in the second toner particles in order to control the crystallization temperature T2 to fall within the above range.

### Amorphous Resin

Examples of the amorphous resin include publicly known amorphous resins, such as an amorphous polyester resin, an amorphous vinyl resin (e.g., a styrene acrylic resin), an epoxy resin, a polycarbonate resin, and a polyurethane resin. Among these, an amorphous polyester resin and an amorphous vinyl resin (in particular, a styrene acrylic resin) are preferable, and an amorphous polyester resin is more preferable.

### Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentacrythritol.

The above polyhydric alcohols may be used alone or in combination of two or more.

The glass transition temperature Tg of the amorphous polyester resin is preferably 50° C. or more and 80° C. or less and is more preferably 50° C. or more and 65° C. or less.

The glass transition temperature of a resin is determined from a differential scanning calorimetry (DSC) curve obtained by DSC. More specifically, the glass transition temperature of a resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the amorphous polyester resin is preferably 5,000 or more and 1,000,000 or less and is more preferably 7,000 or more and 500,000 or less.

The number average molecular weight Mn of the amorphous polyester resin may be 2,000 or more and 100,000 or less.

The molecular weight distribution index Mw/Mn of the amorphous polyester resin is preferably 1.5 or more and 100 or less and is more preferably 2 or more and 60 or less.

The weight average molecular weight and number average molecular weight of a resin are determined by gel permeation chromatography (GPC). Specifically, the molecular weights of a resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

### Content of Binder Resin

The content of the binder resin is, for example, preferably 40% by mass or more and 95% by mass or less, is more preferably 50% by mass or more and 90% by mass or less, and is further preferably 60% by mass or more and 85% by mass or less of the total amount of the toner particles.

### Granular Material

The granular material may be any material other than a resin. Examples of the granular material include a pigment and inorganic particles.

Examples of the pigment include the pigments known in the related art as colorants. Specific examples thereof include the aggregation-induced emission colorant and nonfluorescent pigment described below.

Examples of the inorganic particles include particles of metal oxides, such as silica, titanium oxide, zinc oxide, and tin oxide; particles of metal compounds, such as barium sulfate, aluminum borate, and potassium titanate; and particles of metals, such as gold, silver, and copper.

The above granular materials may be used alone or in combination of two or more.

In the case where the granular material is inorganic particles, the granular material may be colorless and transparent in order to make it easy to control the hue of the toner while controlling the crystallization temperature. Note that the expression “granular material is colorless and transparent” used herein means that the lightness L*, chromaticity a*, chromaticity b*, and haze value that are determined by analyzing a sample prepared by the following method are 95% or more, −5 or more and 5 or less, −5 or more and 5 or less, and 5% or less, respectively.

Specifically, the lightness L*, chromaticity a*, and chromaticity b* are determined by analyzing a powder sample of the granular material charged in a cell with a spectrophotometric colorimeter “SE7700” produced by Nippon Denshoku Industries Co., Ltd.

The haze value is determined using a haze meter “HZ-V3” produced by Suga Test Instruments Co., Ltd. In the measurement of the haze value, first, 95 g of a general-purpose polyester resin is mixed with 5 g of the granular material and 50 g of acetone, and the resulting mixture is stirred with a paint shaker. The mixture is then applied onto a glass plate with a bar coater produced by Dai-ichi Rika Co., Ltd. so as to form a film-like sample having a thickness of 10 μm. The sample is dried and subsequently analyzed.

Examples of the colorless and transparent granular material include silica particles, nano-sized titanium oxide particles (e.g., titanium oxide particles having a volume average size of 100 nm or less), and nano-sized zinc oxide particles (e.g., zinc oxide particles having a volume average size of 100 nm or less).

In the case where the granular material is a pigment, the volume average size of particles of the granular material is, for example, 10 nm or more and 150 nm or less. The above volume average size is preferably 50 nm or more and 150 nm or less and is more preferably 80 nm or more and 130 nm or less in consideration of dispersibility.

In the case where the granular material is inorganic particles, the volume average size of particles of the granular material is preferably 10 nm or more and 150 nm or less, is more preferably 10 nm or more and 100 nm or less, and is further preferably 10 nm or more and 50 nm or less in consideration of transparency.

The volume average size of particles of the granular material is determined in the following manner. The particle diameter distribution of the particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v.

The content of the granular material in the first toner particles is preferably 0.5% by mass or more and 10% by mass or less, is more preferably 1% by mass or more and 8% by mass or less, and is further preferably 2% by mass or more and 6% by mass or less of the total amount of the first toner particles in order to control the crystallization temperature T1 to fall within the above range. In the case where the first toner particles include a plurality of types of granular materials, the content of the granular material refers to the total content of the granular materials.

### Colorant

As described above, the dye toner particles include a dye as a principal colorant component and may include, as needed, a colorant other than a dye. The dye toner particles may include only one type of a colorant and may include two or more types of colorants.

Examples of the dye include a fluorescent dye and a nonfluorescent dye. Note that a fluorescent dye is a dye that fluoresces upon receiving light energy from the outside, while a nonfluorescent dye is a dye that does not fluoresce upon receiving light energy from the outside. In general, a fluorescent dye exhibits a color due to the reflection and emission of light, while a nonfluorescent dye exhibits a color due to only the reflection of light.

Examples of the colorant other than a dye include an aggregation-induced emission colorant and a nonfluorescent pigment. An aggregation-induced emission colorant is a colorant having a property of fluorescing when a number of molecules of the colorant are aggregated together to form a crystalline state (i.e., an aggregated state) although a molecule of the colorant does not fluoresce alone, that is, capable of aggregation-induced emission (AIE). A nonfluorescent pigment is a pigment that does not fluoresce upon receiving light energy from the outside.

### Fluorescent Dye

Examples of the fluorescent dye include fluorescent dyes that belong to the following: a naphthalimide; a cationic or noncationic coumarin; a xanthenodiquinolizine (e.g., a sulforhodamine); an azaxanthene; a naphtholactam; an azlactone; an oxazine; a thiazine; a dioxazine; and an azo, azomethine, or methine-type monocationic or polycationic fluorescent dye or a mixture thereof.

Examples of the fluorescent dye include a fluorescent dye having a cationic group.

The cationic group is preferably an onium group, is more preferably an ammonium group, an iminium group, or a pyridinium group, is further preferably an ammonium group, and is particularly preferably a quaternary ammonium group in consideration of fluorescence intensity.

The number of cationic groups included in the fluorescent dye may be only one or two or more. The number of cationic groups included in the fluorescent dye is preferably 1 to 4, is more preferably 1 or 2, and is particularly preferably 1 in consideration of fluorescence intensity.

Specific examples of the fluorescent dye include C. I. Basic Red 1 (Rhodamine 6G), C. I. Basic Red 1:1, C. I. Basic Red 2, C. I. Basic Red 12, C. I. Basic Red 13, C. I. Basic Red 14, C. I. Basic Red 15, C. I. Basic Red 36, C. I. Basic Violet 7, C. I. Basic Violet 10 (Rhodamine B), C. I. Basic Violet 11 (Rhodamine 3B), C. I. Basic Violet 11:1 (Rhodamine A), C. I. Basic Violet 15, C. I. Basic Violet 16, C. I. Basic Violet 27, C. I. Basic Yellow 1, C. I. Basic Yellow 2, C. I. Basic Yellow 9, C. I. Basic Yellow 24, C. I. Basic Yellow 40, C. I. Basic Orange 15, C. I. Basic Orange 22, C. I. Basic Blue 1, C. I. Basic Blue 3, C. I. Basic Blue 7, C. I. Basic Blue 9, C. I. Basic Blue 45, C. I. Basic Green 1, C. I. Acid Yellow 3, C. I. Acid Yellow 7, C. I. Acid Yellow 73, C. I. Acid Yellow 87, C. I. Acid Yellow 184, C. I. Acid Yellow 245, C. I. Acid Yellow 250, C. I. Acid Red 51, C. I. Acid Red 52, C. I. Acid Red 57, C. I. Acid Red 77, C. I. Acid Red 87, C. I. Acid Red 89, C. I. Acid Red 92, C. I. Acid Blue 9, C. I. Acid Black 2, C. I. Solvent Yellow 43, C. I. Solvent Yellow 44, C. I. Solvent Yellow 85, C. I. Solvent Yellow 98, C. I. Solvent Yellow 116, C. I. Solvent Yellow 131, C. I. Solvent Yellow 145, C. I. Solvent Yellow 160:1, C. I. Solvent Yellow 172, C. I. Solvent Yellow 185, C. I. Solvent Yellow 195, C. I. Solvent Yellow 196, C. I. Solvent Orange 63, C. I. Solvent Orange 112, C. I. Solvent Red 49, C. I. Solvent Red 149, C. I. Solvent Red 175, C. I. Solvent Red 196, C. I. Solvent Red 197, C. I. Solvent Blue 5, C. I. Solvent Green 5, C. I. Solvent Green 7, C. I. Direct Yellow 27, C. I. Direct Yellow 85, C. I. Direct Yellow 96, C. I. Direct Orange 8, C. I. Direct Red 2, C. I. Direct Red 9, C. I. Direct Blue 22, C. I. Direct Blue 199, C. I. Direct Green 6, C. I. Disperse Yellow 11, C. I. Disperse Yellow 82, C. I. Disperse Yellow 139, C. I. Disperse Yellow 184, C. I. Disperse Yellow 186, C. I. Disperse Yellow 199, C. I. Disperse Yellow 202, C. I. Disperse Yellow 232, C. I. Disperse Orange 11, C. I. Disperse Orange 32, C. I. Disperse Red 58, C. I. Disperse Red 274, C. I. Disperse Red 277, C. I. Disperse Red 303, C. I. Disperse Blue 7, C. I. Reactive Yellow 78, and C. I. Vat Red 41.

A fluorescent pigment produced by dispersing a fluorescent dye in a resin (i.e., pigmented fluorescent dye) is also considered as a fluorescent dye.

Examples of the pigmented fluorescent dye include resin particles produced by dispersing the various fluorescent dyes described above in resins, such as a melamine resin, an alkyd resin, a vinyl chloride resin, an acrylic resin, a polyester resin, an amino resin, a formaldehyde-condensed resin, and the like.

Examples of the pigmented fluorescent dye include powder fluorescent pigments produced by SINLOIHI CO., LTD. (SINLOIHI COLOR SX-100 Series, SX-200 Series, SX-300 Series, NEZ-100 Series, etc.), fluorescent pigments produced by Day-Glo Color Corp. (T Series, GT Series, ZQ Series, GPL Series, etc.), and fluorescent pigments produced by Nippon Fluorescent Chemical Co., Ltd. (e.g., NKV-S Series and NKW-3200E Series).

The fluorescent dye may be a fluorescent brightening agent.

Examples of the fluorescent brightening agent include a benzoxazole derivative, a benzothiazole derivative, a benzimidazole derivative, a stilbene derivative, a coumarin derivative, a biphenyl derivative, a naphthalimide derivative, and a benzidine derivative. Specific examples thereof include Fluorescent Brightener 184 and Fluorescent Brightener 393.

### Nonfluorescent Dye

The nonfluorescent dye may be any dye that does not have a fluorescence property, and the color, etc. of the nonfluorescent dye are not limited. Examples of the nonfluorescent dye include a nonfluorescent green dye, a nonfluorescent red dye, a nonfluorescent yellow dye, a nonfluorescent pink dye, a nonfluorescent orange dye, and a nonfluorescent purple dye.

### Aggregation-Induced Emission Colorant

The aggregation-induced emission colorant is not limited and may be any colorant having the above-described property.

Specific examples of the aggregation-induced emission colorant include C. I. Pigment Yellow 101, a boron difluoride derivative of C. I. Pigment Yellow 101, and 1,2,3,4-tetrachloro-11H-isoindolo [2,1-a]benzimidazol-11-one.

Among these, C. I. Pigment Yellow 101 is preferably used as an aggregation-induced emission colorant in consideration of chroma and fluorescence intensity.

Note that 1,2,3,4-tetrachloro-11H-isoindolo [2,1-a]benzimidazol-11-one is available as “RADGLO VSF-0-05” produced by Radiant Color.

### Nonfluorescent Pigment

The color, etc. of the nonfluorescent pigment are not limited; the nonfluorescent pigment may be any pigment that does not have fluorescence. Examples of the nonfluorescent pigment include nonfluorescent green, red, yellow, pink, orange, and purple pigments.

Examples of the nonfluorescent pigment include the following pigments: carbon black, chrome yellow, Hansa Yellow, Benzidine Yellow, threne yellow, quinoline yellow, Pigment Yellow, Permanent Orange GTR, Pyrazolone Orange, Vulcan Orange, Watch Young Red, Permanent Red, Brilliant Carmine 3B, Brilliant Carmine 6B, Dupont Oil Red, Pyrazolone Red, Lithol Red, Rhodamine B Lake, Lake Red C, Pigment Red, Pigment Orange, Rose Bengal, aniline blue, ultramarine blue, Calco Oil Blue, methylene blue chloride, phthalocyanine blue, Pigment Blue, phthalocyanine green, Malachite green oxalate, titanium oxide, zinc oxide, calcium carbonate, basic lead carbonate, a zinc sulfate-barium sulfate mixture, zinc sulfate, silicon dioxide, and aluminum oxide.

### Content of Colorant

The content of the colorant is preferably, for example, 0.5% by mass or more and 30% by mass or less and is more preferably 1% by mass or more and 15% by mass or less of the total amount of the toner particles.

### Release Agent

Examples of the release agent include, but are not limited to, hydrocarbon waxes, such as a microcrystalline wax; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent included in the first toner particles is preferably 50° C. or more and 110° C. or less, is more preferably 60° C. or more and 100° C. or less, and is further preferably 70° C. or more and 100° C. or less in order to control the crystallization temperature T1 to fall within the above range.

The melting temperature of the release agent included in the second toner particles is preferably 50° C. or more and 110° C. or less, is more preferably 60° C. or more and 100° C. or less, and is further preferably 70° C. or more and 100° C. or less in order to control the crystallization temperature T2 to fall within the above range.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The content of the release agent is, for example, preferably 1% by mass or more and 20% by mass or less and is more preferably 5% by mass or more and 15% by mass or less of the total amount of the toner particles.

### Other Additives

Examples of the other additives include additives known in the related art, such as a magnetic substance, a charge-controlling agent, and inorganic particles. These additives may be added to the toner particles as internal additives.

### Properties, Etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including a binder resin and, as needed, other additives such as a colorant and a release agent and by a coating layer including a binder resin.

The volume average diameter D50v of the toner particles is preferably 2 μm or more and 10 μm or less and is more preferably 4 μm or more and 8 μm or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5% aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}.

The toner particles preferably have an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O·(TiO₂) n particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 5% by mass or less and is more preferably 0.01% by mass or more and 2.0% by mass or less of the amount of the toner particles.

### Method for Producing Toner

A method for producing the toner according to this exemplary embodiment is described below.

The toner according to the exemplary embodiment is produced by, after the preparation of the toner particles, depositing an external additive on the surfaces of the toner particles.

The toner particles may be prepared by any dry process, such as knead pulverization, or any wet process, such as aggregation coalescence, suspension polymerization, or dissolution suspension. However, a method for preparing the toner particles is not limited thereto, and any suitable method known in the related art may be used.

Among these methods, aggregation coalescence may be used in order to prepare the toner particles.

Specifically, for example, in the case where aggregation coalescence is used for producing the toner particles, the toner particles are produced by the following steps:
preparing a resin particle dispersion liquid in which particles of a resin that serves as a binder resin are dispersed (i.e., resin particle dispersion liquid preparation step);
causing the resin particles (and other particles as needed) to aggregate with one another in the resin particle dispersion liquid (or a dispersion liquid that further includes the other particle dispersion liquid as needed) to form aggregated particles (i.e., aggregated particle formation step); and
heating the resulting aggregated particle dispersion liquid in which the aggregated particles are dispersed to cause fusion and coalescence of the aggregated particles and form toner particles (i.e., fusion and coalescence step).

Each of the above steps is described below in detail.

Hereinafter, a method for preparing toner particles including a colorant and a release agent is described. However, it should be noted that the colorant and the release agent are optional. It is needless to say that additives other than a colorant or a release agent may be used.

### Resin Particle Dispersion Liquid Preparation Step

First, a resin particle dispersion liquid in which particles of a resin that serves as a binder resin are dispersed is prepared. Furthermore, for example, a colorant particle dispersion liquid in which particles of a colorant are dispersed and a release agent particle dispersion liquid in which particles of a release agent are dispersed are prepared.

The resin particle dispersion liquid is prepared by, for example, dispersing resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the resin particle dispersion liquid by phase-inversion emulsification or the like.

Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to convert the resin (i.e., perform phase inversion) from W/O to O/W, form a discontinuous phase, and disperse the resin in the aqueous medium in the form of particles.

The volume average size of the resin particles dispersed in the resin particle dispersion liquid is preferably, for example, 0.01 μm or more and 1 μm or less, is more preferably 0.08 μm or more and 0.8 μm or less, and is further preferably 0.1 μm or more and 0.6 μm or less.

The volume average size of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average sizes of particles included in the other dispersion liquids are also determined in the above-described manner.

The content of the resin particles included in the resin particle dispersion liquid is, for example, preferably 5% by mass or more and 50% by mass or less and is more preferably 10% by mass or more and 40% by mass or less.

The colorant particle dispersion liquid, the release agent particle dispersion liquid, and the like are also prepared as in the preparation of the resin particle dispersion liquid. In other words, the above-described specifications for the volume average diameter of the particles included in the resin particle dispersion liquid, the dispersion medium of the resin particle dispersion liquid, the dispersion method used for preparing the resin particle dispersion liquid, and the content of the particles in the resin particle dispersion liquid can also be applied to colorant particles dispersed in the colorant particle dispersion liquid and release agent particles dispersed in the release agent particle dispersion liquid.

### Aggregated Particle Formation Step

The resin particle dispersion liquid is mixed with the colorant particle dispersion liquid and the release agent particle dispersion liquid.

In the resulting mixed dispersion liquid, heteroaggregation of the resin particles with the colorant particles and the release agent particles is performed in order to form aggregated particles including the resin particles, the colorant particles, and the release agent particles, the aggregated particles having a diameter closer to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to the glass transition temperature of the resin particles (specifically, e.g., [Glass transition temperature of the resin particles−30° C.] or more and [the Glass transition temperature−10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants, inorganic metal salts, and divalent or higher metal complexes that have a polarity opposite to that of the surfactant included in the mixed dispersion liquid as a dispersant. In particular, using a metal complex as a coagulant reduces the amount of surfactant used and, as a result, charging characteristics may be enhanced.

An additive capable of forming a complex or a bond similar to a complex with the metal ions contained in the coagulant may optionally be used. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and iminodiacetic acid (IDA), nitrilotriacetic acid (NTA), and ethylenediaminetetraacetic acid (EDTA).

The amount of the chelating agent used is, for example, preferably 0.01 parts by mass or more and 5.0 parts by mass or less and is more preferably 0.1 parts by mass or more and less than 3.0 parts by mass relative to 100 parts by mass of the resin particles.

### Fusion Coalescence Step

The aggregated particle dispersion liquid in which the aggregated particles are dispersed is heated to, for example, a temperature equal to or higher than the glass transition temperature of the resin particles (e.g., [Glass transition temperature of the resin particles+10° C.] or more and [the Glass transition temperature+30° C.] or less) in order to perform fusion and coalescence of the aggregated particles and form toner particles.

The toner particles are produced through the above-described steps.

The toner particles may be produced by, subsequent to the preparation of the aggregated particle dispersion liquid in which the aggregated particles are dispersed, mixing the aggregated particle dispersion liquid with a resin particle dispersion liquid in which resin particles are dispersed and causing aggregation such that the resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method used in the solid-liquid separation step include, but are not limited to, suction filtration and pressure filtration from the viewpoint of productivity. Examples of a drying method used in the drying step include, but are not limited to, freeze-drying, flash drying, fluidized drying, and vibrating fluidized drying from the viewpoint of productivity.

The toner according to the exemplary embodiment is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer Set

An electrostatic image developer set according to an exemplary embodiment of the disclosure includes yellow, magenta, cyan, and black developers including the yellow, magenta, cyan, and black toners included in the toner set according to an exemplary embodiment of the disclosure, respectively; a first developer including the first toner included in the toner set according to an exemplary embodiment of the disclosure; and a second developer including the second toner included in the toner set according to an exemplary embodiment of the disclosure.

Hereinafter, the yellow, magenta, cyan, and black developers are referred to collectively as “YMCK developers”.

Each of the electrostatic image developers may be a single component developer including a toner or may be a two-component developer that is a mixture of a toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin.

The coat resin and the matrix resin may optionally include additives, such as conductive particles.

Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and, as needed, various types of additives in a suitable solvent. The type of the solvent is not limited and may be selected with consideration of the type of the resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

### Image Forming Apparatus and Image Forming Method

An image forming apparatus and an image forming method according to an exemplary embodiment of the disclosure are described below.

An image forming apparatus according to an exemplary embodiment of the disclosure includes yellow, magenta, cyan, and black image formation units that form yellow, magenta, cyan, and black images using the yellow, magenta, cyan, and black toners included in the toner set according to an exemplary embodiment of the disclosure, respectively; a first image formation unit that forms a first image using the first toner included in the toner set according to an exemplary embodiment of the disclosure; a second image formation unit that forms a second image using the second toner included in the toner set according to an exemplary embodiment of the disclosure; a transfer unit that transfers the yellow, magenta, cyan, black, first, and second images to a recording medium; and a fixing unit that fixes a toner image to the recording medium, the toner image including the yellow, magenta, cyan, black, first, and second images stacked on top of one another.

In the toner image, the first and second images may be stacked on top of each other. In this exemplary embodiment, since the crystallization temperatures T1 and T2 fall within the above ranges, the occurrence of both hot offset and cold offset may be reduced even when the first and second images are stacked on top of each other.

In the toner image, one of the layer farthest from the recording medium and the layer second farthest from the recording medium may be the first image and the other may be the second image. In other words, the first and second toners included in the toner set according to an exemplary embodiment of the disclosure may be used for forming two of the layers constituting the toner image which are farthest from the recording medium (i.e., the two layers farther from the recording medium than the images formed using the YMCK toners). In this exemplary embodiment, since the crystallization temperatures T1 and T2 fall within the above ranges, the occurrence of both hot offset and cold offset may be reduced even when the first and second images are two of the layers constituting the toner image which are farthest from the recording medium.

In the toner image, the layer farthest from the recording medium may be the first image and the layer second farthest from the recording medium may be the second image. In other words, the first toner included in the toner set according to an exemplary embodiment of the disclosure may be used for forming one of the layers constituting the toner image which is farthest from the recording medium, and the second toner included in the toner set may be used for forming one of the layers constituting the toner image which is second farthest from the recording medium. In this exemplary embodiment, since the crystallization temperatures T1 and T2 fall within the above ranges, the occurrence of both hot offset and cold offset may be reduced even when the first image is the layer farthest from the recording medium and the second image is the layer second farthest from the recording medium.

The image forming apparatus according to an exemplary embodiment of the disclosure may include yellow, magenta, cyan, and black image formation units and first and second image formation units that each include an image holding member, a charging unit that charges the surface of the image holding member, an electrostatic image formation unit that forms an electrostatic image on the charged surface of the image holding member, and a developing unit that develops the electrostatic image formed on the surface of the image holding member with an electrostatic image developer to form a toner image.

Alternatively, the image forming apparatus according to an exemplary embodiment of the disclosure may include an image holding member, a charging unit that charges the surface of the image holding member, an electrostatic image formation unit that forms an electrostatic image on the charged surface of the image holding member, and yellow, magenta, cyan, and black image formation units and first and second image formation units that include yellow, magenta, cyan, and black developing units and first and second developing units, respectively, which develop the electrostatic image formed on the surface of the image holding member with an electrostatic image developer to form a toner image.

The image forming apparatus according to an exemplary embodiment of the disclosure may perform an image forming method (i.e., an image forming method according to an exemplary embodiment of the disclosure) that includes yellow, magenta, cyan, and black image formation steps of forming yellow, magenta, cyan, and black images using the yellow, magenta, cyan, and black toners included in the toner set according to an exemplary embodiment of the disclosure, respectively; a first image formation step of forming a first image using the first toner included in the toner set according to an exemplary embodiment of the disclosure; a second image formation step of forming a second image using the second toner included in the toner set according to an exemplary embodiment of the disclosure; a transfer step of transferring the yellow, magenta, cyan, black, first, and second images to a recording medium; and a fixing step of fixing a toner image to the recording medium, the toner image including the yellow, magenta, cyan, black, first, and second images stacked on top of one another.

The image forming apparatus according to an exemplary embodiment of the disclosure may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

An example of the image forming apparatus according to an exemplary embodiment of the disclosure is described below, but the image forming apparatus is not limited thereto. Hereinafter, only components illustrated in drawings are described; others are omitted.

A sextuple tandem image forming apparatus that includes six image formation units arranged in series is described below as an example of the image forming apparatus according to an exemplary embodiment of the disclosure. Note that the tandem image forming apparatus is not limited to this.

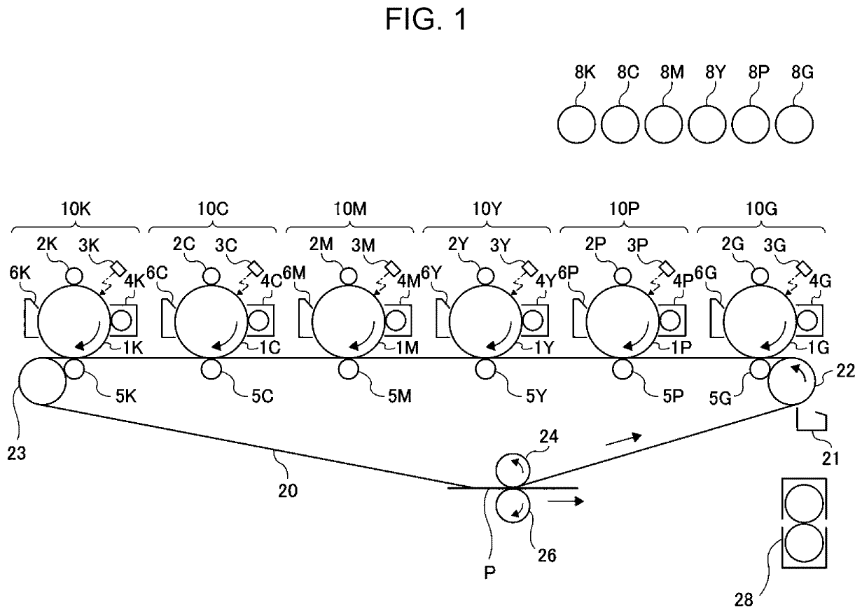

FIG. 1 schematically illustrates the image forming apparatus according to an exemplary embodiment of the disclosure. FIG. 1 illustrates a sextuple tandem, intermediate transfer-type image forming apparatus

The image forming apparatus illustrated in FIG. 1 includes a first image formation unit 10G (i.e., an example of the first image formation unit), second image formation unit 10P (i.e., an example of the second image formation unit), a yellow image formation unit 10Y (i.e., an example of the yellow image formation unit), a magenta image formation unit 10M (i.e., an example of the magenta image formation unit), a cyan image formation unit 10C (i.e., an example of the cyan image formation unit), and a black image formation unit 10K (i.e., an example of the black image formation unit), which are electrophotographic image formation units that form green (G), pink (P), yellow (Y), magenta (M), cyan (C), and black (K) images, respectively, on the basis of color separation image data. The image formation units (hereinafter, referred to simply as “units”) 10G, 10P, 10Y, 10M, 10C, and 10K are horizontally arranged in parallel at a predetermined distance from one another. The units 10G, 10P, 10Y, 10M, 10C, and 10K may be process cartridges detachably attachable to the image forming apparatus.

Although the image forming apparatus illustrated in FIG. 1 includes pink (P) and green (G) image formation units, the structure of the image forming apparatus is not limited to this.

An intermediate transfer belt (an example of the intermediate transfer body) 20 runs below and extends over the units 10G, 10P, 10Y, 10M, 10C, and 10K so as to pass through the units. The intermediate transfer belt 20 is wound around a drive roller 22, a support roller 23, and a counter roller 24 arranged to contact with the inner surface of the intermediate transfer belt 20 and runs in the direction from the second unit 10P to the first unit 10G. An intermediate transfer body-cleaning device 21 is disposed so as to contact with the image holding member-side surface of the intermediate transfer belt 20 and to face the drive roller 22.

Developing devices (i.e., examples of developing units) 4G, 4P, 4Y, 4M, 4C, and 4K of the units 10G, 10P, 10Y, 10M, 10C, and 10K are supplied with fluorescent green, fluorescent pink, yellow, magenta, cyan, and black toners stored in toner cartridges 8G, 8P, 8Y, 8M, 8C, and 8K, respectively.

Since the units 10G, 10P, 10Y, 10M, 10C, and 10K have the same structure and the same action, the following description is made with reference to, as a representative, the unit 10G that forms a green image.

The unit 10G includes a photosensitive member 1G serving as an image holding member. The following components are disposed around the photosensitive member 1G sequentially in the counterclockwise direction: a charging roller (example of the charging unit) 2G that charges the surface of the photosensitive member 1G at a predetermined potential; an exposure device (example of the electrostatic image formation unit) 3G that forms an electrostatic image by irradiating the charged surface of the photosensitive member 1G with a laser beam based on a color separated image signal; a developing device (example of the developing unit) 4G that develops the electrostatic image by supplying a toner to the electrostatic image; a first transfer roller (example of the first transfer subunit) 5G that transfers the developed toner image to the intermediate transfer belt 20; and a photosensitive-member cleaning device (example of the cleaning unit) 6G that removes a toner remaining on the surface of the photosensitive member 1G after the first transfer.

The first transfer roller 5G is disposed so as to contact with the inner surface of the intermediate transfer belt 20 and to face the photosensitive member 1G. Each of the first transfer rollers 5G, 5P, 5Y, 5M, 5C, and 5K of the respective units is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a green image in the unit 10G is described below.

Before the action starts, the surface of the photosensitive member 1G is charged at a potential of −600 to −800 V by the charging roller 2G.

The photosensitive member 1G is formed by stacking a photosensitive layer on a conductive substrate (e.g., volume resistivity at 20° C.: 1×10⁻⁶ Ω·cm or less). The photosensitive layer is normally of high resistance (comparable with the resistance of ordinary resins), but, upon being irradiated with the laser beam, the specific resistance of the portion irradiated with the laser beam varies. Thus, the exposure device 3G irradiates the surface of the charged photosensitive member 1G with the laser beam on the basis of the image data of the green image sent from the controller (not illustrated). As a result, an electrostatic image of green image pattern is formed on the surface of the photosensitive member 1G.

The term “electrostatic image” used herein refers to an image formed on the surface of the photosensitive member 1G by charging, the image being a “negative latent image” formed by irradiating a portion of the photosensitive layer with a laser beam emitted by the exposure device 3G to reduce the specific resistance of the irradiated portion such that the charges on the irradiated surface of the photosensitive member 1G discharge while the charges on the portion that is not irradiated with the laser beam remain.

The electrostatic image, which is formed on the photosensitive member 1G as described above, is sent to the predetermined developing position by the rotating photosensitive member 1G. The electrostatic image on the photosensitive member 1G is developed and visualized in the form of a toner image by the developing device 4G at the developing position.

The developing device 4G includes an electrostatic image developer including, for example, at least, a fluorescent green toner and a carrier. The fluorescent green toner is stirred in the developing device 4G to be charged by friction and supported on a developer roller (example of the developer support), carrying an electric charge of the same polarity (i.e., negative) as the electric charge generated on the photosensitive member 1G. The fluorescent green toner is electrostatically adhered to the erased latent image portion on the surface of the photosensitive member 1G as the surface of the photosensitive member 1G passes through the developing device 4G. Thus, the latent image is developed using the fluorescent green toner. The photosensitive member 1G on which the fluorescent green toner image is formed keeps rotating at the predetermined rate, thereby transporting the toner image developed on the photosensitive member 1G to the predetermined first transfer position.

Upon the fluorescent green toner image on the photosensitive member 1G reaching the first transfer position, first transfer bias is applied to the first transfer roller 5G so as to generate an electrostatic force on the toner image in the direction from the photosensitive member 1G toward the first transfer roller 5G. Thus, the toner image on the photosensitive member 1G is transferred to the intermediate transfer belt 20. The transfer bias applied has the opposite polarity (+) to that of the toner (−) and controlled to be, for example, in the first unit 10G, +10 μA by a controller (not illustrated).

After the toner image has been transferred from the photosensitive member 1G to the intermediate transfer belt 20, the photosensitive member 1G keeps rotating and is brought into contact with a cleaning blade included in the photosensitive member cleaning device 6G. The toner particles remaining on the photosensitive member 1G are removed by the photosensitive-member cleaning device 6G and then collected.

The intermediate transfer belt 20 is successively transported through the image formation units 10G, 10P, 10Y, 10M, 10C, and 10K while toner images of the respective colors are stacked on top of another.

The resulting intermediate transfer belt 20 on which toner images of six colors are multiple-transferred in the respective units is then transported to a second transfer section including a counter roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the counter roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

After the toner image has been transferred from the intermediate transfer belt 20 to the recording paper P, the intermediate transfer belt 20 keeps running and is brought into contact with a cleaning blade included in the intermediate transfer body cleaning device 21. The toner particles remaining on the intermediate transfer belt 20 are removed by the intermediate transfer body cleaning device 21 and then collected.

The recording paper P on which the toner image is transferred is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge Set

A process cartridge according to an exemplary embodiment of the disclosure is described below.

The process cartridge according to an exemplary embodiment of the disclosure is a process cartridge detachably attachable to an image forming apparatus, the process cartridge including yellow, magenta, cyan, and black developing units each including a corresponding one of the yellow, magenta, cyan, and black developers included in the electrostatic image developer set according to an exemplary embodiment of the disclosure, a first developing unit including the first developer included in the electrostatic image developer set, and a second developing unit including the second developer included in the electrostatic image developer set.

The structure of the process cartridge according to an exemplary embodiment of the disclosure is not limited to the above-described one. The process cartridge may further include, in addition to the developing device, at least one unit selected from an image holding member, a charging unit, an electrostatic image formation unit, a transfer unit, etc.

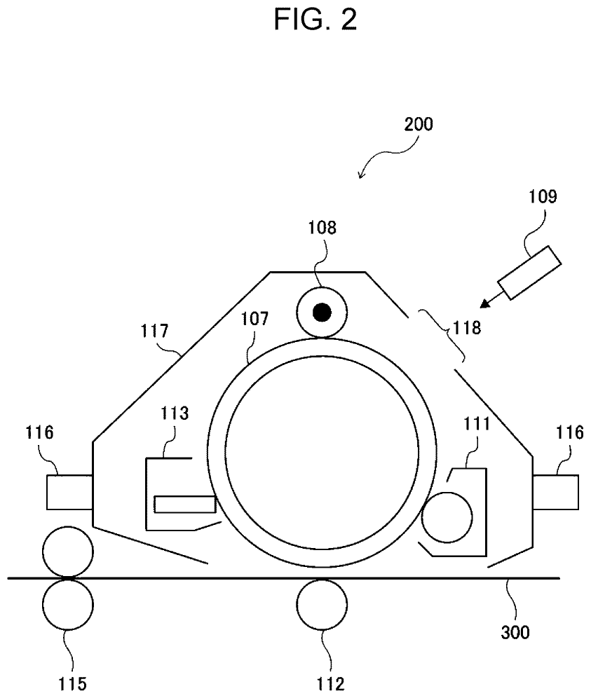

An example of the process cartridge according to an exemplary embodiment of the disclosure is described below, but the process cartridge is not limited thereto. Hereinafter, only components illustrated in FIG. 2 are described; others are omitted.

FIG. 2 schematically illustrates the process cartridge according to an exemplary embodiment of the disclosure.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge set according to an exemplary embodiment of the disclosure is described below.

The toner cartridge set according to an exemplary embodiment of the disclosure is a toner cartridge set detachably attachable to an image forming apparatus, the toner cartridge set including yellow, magenta, cyan, and black toner cartridges each including a corresponding one of the yellow, magenta, cyan, and black toners included in the toner set according to an exemplary embodiment of the disclosure, a first toner cartridge including the first toner included in the toner set, and a second toner cartridge including the second toner included in the toner set.

The toner cartridges each include a replenishment toner that is to be supplied to the developing unit disposed inside an image forming apparatus.

The image forming apparatus illustrated in FIG. 1 is an image forming apparatus that includes the toner cartridges 8G, 8P, 8Y, 8M, 8C, and 8K detachably attached to the image forming apparatus. Each of the developing devices 4G, 4P, 4Y, 4M, 4C, and 4K is connected to a specific one of the toner cartridges which corresponds to the color of the developing device with a toner supply pipe (not illustrated). When the amount of toner contained in a toner cartridge is small, the toner cartridge is replaced. A set of the toner cartridges 8G, 8P, 8Y, 8M, 8C, and 8K is an example of the toner cartridge set according to an exemplary embodiment of the disclosure and includes the toner set according to an exemplary embodiment of the disclosure. The toner cartridges 8G, 8P, 8Y, 8M, 8C, and 8K include fluorescent green, fluorescent pink, yellow, magenta, cyan, and black toners, respectively.

### EXAMPLES

Details of the exemplary embodiments of the present disclosure are described with reference to Examples below. It should be noted that the exemplary embodiments of the present disclosure are not limited by Examples.

Hereinafter, all “part” and “%” are on a mass basis unless otherwise specified.

Synthesis, treatment, production, and the like are conducted at room temperature (25° C.±3° C.) unless otherwise specified.

### Preparation of Fluorescent Green Toner 1 and Developer 1

### Synthesis of Crystalline Resin Particle Dispersion Liquid (1)

1,10-Dodecanedioic acid: 50 mol %
1,9-Nonanediol: 50 mol %

The above monomer components are charged into a reactor equipped with a stirrer, a thermometer, a condenser, and a nitrogen gas introduction tube. After the inside of the reactor has been purged with a dry nitrogen gas, 0.25 parts of titanium tetrabutoxide (i.e., a reagent) relative to 100 parts of the monomer components is charged into the reactor. The resulting mixture is stirred for 3 hours at 170° C. under a nitrogen gas stream to cause a reaction. Subsequently, the temperature is increased to 210° C. over 1 hour and the pressure inside the reactor is reduced to 3 kPa. Then, a reaction is conducted for 13 hours under reduced pressure while stirring is performed. Hereby, a crystalline polyester resin (1) is prepared.

The melting temperature of the crystalline polyester resin (1) determined by DSC is 73.6° C. The mass average molecular weight Mw of the crystalline polyester resin (1) determined by GPC is 25,000. The number average molecular weight Mn of the crystalline polyester resin (1) is 10,500. The acid value AV of the crystalline polyester resin (1) is 10.1 mgKOH/g.

Into a jacketed reaction vessel (“BJ-30N” produced by TOKYO RIKAKIKAI CO, LTD.) equipped with a condenser, a thermometer, a water dropper, and an anchor impeller, 300 parts of the crystalline polyester resin (1), 160 parts of methyl ethyl ketone (i.e., a solvent), and 100 parts of isopropyl alcohol (i.e., a solvent) are charged. While the temperature is maintained at 70° C. with a water circulation thermostat, the resin is dissolved by performing stirring at 100 rpm.

Then, the rotation speed at which stirring is performed is changed to 150 rpm, and the temperature of the water circulation thermostat is set to 66° C. Subsequently, 17 parts of a 10-mass % ammonia water (i.e., a reagent) is charged into the vessel over 10 minutes, and 900 parts of ion-exchange water maintained at 66° C. is added dropwise to the vessel at a rate of 7 part/min in total in order to perform phase inversion. Hereby, an emulsion is prepared.

Immediately after this, 800 parts of the emulsion and 700 parts of ion-exchange water are charged into an eggplant flask, which is connected to an evaporator (produced by (TOKYO RIKAKIKAI CO, LTD.) equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. When the amount of the solvent collected reaches 1,100 parts, the pressure is increased to normal pressure and the eggplant flask is cooled with water. Hereby, a dispersion liquid is prepared. The dispersion liquid does not have an odor of the solvent. The volume average size of the resin particles included in the dispersion liquid is 130 nm. Ion-exchange water is added to the dispersion liquid in order to adjust the solid component concentration in the dispersion liquid to 20%. Hereby, a crystalline resin particle dispersion liquid (1) is prepared.

### Preparation of Amorphous Resin Particle Dispersion Liquid (1)

Terephthalic acid: 30 molar parts
Fumaric acid: 70 molar parts
Bisphenol A-ethylene oxide adduct: 5 molar parts
Bisphenol A-propylene oxide adduct: 95 molar parts

The above materials are charged into a flask equipped with a stirrer, a nitrogen introduction tube, a temperature sensor, and a fractionating column. After the temperature of the resulting mixture has been increased to 220° C. over 1 hour, 1 part of titanium tetraethoxide relative to 100 parts of the materials is charged into the flask. While the product water is distilled away, the temperature is increased to 230° C. over 30 minutes. After the dehydration condensation reaction has been continued for 1 hour at the above temperature, the reaction product is cooled. Hereby, an amorphous polyester resin (1) having a weight average molecular weight of 18,000 and a glass transition temperature of 60° C. is prepared.

Into a container equipped with a temperature control unit and a nitrogen purge unit, 40 parts of ethyl acetate and 25 parts of 2-butanol are charged in order to prepare a mixed solvent. To the mixed solvent, 100 parts of the amorphous polyester resin (1) is gradually added in order to form a solution. To the solution, a 10-mass % aqueous ammonia solution is added in an amount that corresponds to three times the acid value of the resin in terms of molar ratio, and the resulting mixture is stirred for 30 minutes. Subsequently, the inside of the container is purged with dry nitrogen. While the temperature is kept at 40° C. and the liquid mixture is stirred, 400 parts of ion-exchange water is added dropwise to the container at a rate of 2 part/min. After the addition of ion-exchange water has been finished, the temperature is reduced to room temperature (20° C. to 25° C.). Subsequently, while stirring is performed, bubbling is performed for 48 hours using dry nitrogen in order to reduce the concentration of ethyl acetate and 2-butanol in the resulting resin particle dispersion liquid to 1,000 ppm or less. Then, ion-exchange water is added to the resin particle dispersion liquid in order to adjust the solid content in the resin particle dispersion liquid to 20% by mass. Hereby, an amorphous resin particle dispersion liquid (1) is prepared.

### Preparation of Colorant Particle Dispersion Liquid (1)

Fluorescent dye Solvent Green 5 (C. I. Solvent green 5 “Oracet F Yellow 084”, emission peak: 520 nm) produced by BASF SE: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a colorant particle dispersion liquid (1) is prepared.

### Preparation of Colorant Particle Dispersion Liquid (2)

Nonfluorescent pigment PG36 (C. I. Pigment Green 36 “LIONOL GREEN 8624” produced by Toyocolor Co., Ltd., volume average particle size: 120 nm): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 95 nm with Key Mill (continuous type) “KMC-3”. The solid content in the resulting dispersion liquid is adjusted to 20% by mass. Hereby, a colorant particle dispersion liquid (2) is prepared.

### Preparation of Release Agent Particle Dispersion Liquid (1)

Microcrystalline wax “HiMic-1090” produced by Nippon Seiro Co., Ltd. (melting temperature: 87° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (1) (solid content: 20% by mass), in which release agent particles having a volume average size of 200 nm are dispersed, is prepared.

### Preparation of Fluorescent Green Toner Particles (1)

Crystalline resin particle dispersion liquid (1): 35 parts
Amorphous resin particle dispersion liquid (1): 100 parts
Colorant particle dispersion liquid (1): 125 parts
Colorant particle dispersion liquid (2): 17 parts
Release agent particle dispersion liquid (1): 40 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 100 parts of the amorphous resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, fluorescent green toner particles (1) are prepared. The volume average size of the fluorescent green toner particles (1) is 5.8 μm. The content of the granular material is 4% by mass of the total amount of the fluorescent green toner particles (1).

### Preparation of Toner

With 100 parts by mass of the fluorescent green toner particles (1), 1.5 parts by mass of hydrophobic silica “RY50” produced by Nippon Aerosil Co., Ltd. and 1.0 parts by mass of hydrophobic titanium oxide “T805” produced by Nippon Aerosil Co., Ltd. are mixed using a sample mill at 10,000 revolutions per minute (rpm) for 30 seconds. Subsequently, sieving is performed with a vibration sieve having an opening of 45 μm. Hereby, a fluorescent green toner 1 is prepared. The volume average particle size of the fluorescent green toner 1 is 5.8 μm.

### Preparation of Carrier 1

Ferrite particles (average size: 35 μm): 100 parts
Toluene: 14 parts
Polymethyl methacrylate (PMMA, weight average molecular weight: 75,000): 5 parts
Carbon black “VXC-72” produced by Cabot Corporation (volume resistivity: 100 Ω·cm or less): 0.2 parts

The above materials except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier 1 is prepared.

### Preparation of Electrostatic Image Developer

A developer (i.e., electrostatic image developer) is prepared by mixing 8 parts of the fluorescent green toner 1 with 92 parts of the carrier 1 using a V-blender.

### Preparation of Fluorescent Green Toner 2 and Developer 2

### Preparation of Release Agent Particle Dispersion Liquid (2)

Polyethylene wax “ACCULIN600” produced by Nippon Seiro Co., Ltd. (melting temperature: 94° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (2) (solid content: 20% by mass), in which release agent particles having a volume average size of 200 nm are dispersed, is prepared.

### Preparation of Fluorescent Green Toner Particles (2)

Fluorescent green toner particles (2) are prepared as in the preparation of the fluorescent green toner particles (1), except that the release agent particle dispersion liquid (1) is changed to the release agent particle dispersion liquid (2). The volume average size of the fluorescent green toner particles (2) is 5.9 μm. The content of the granular material is 4% by mass of the total amount of the fluorescent green toner particles (2).

### Preparation of Toner and Developer

A fluorescent green toner 2 and a developer 2 are prepared as in the preparation of the fluorescent green toner 1 and the developer 1, respectively, except that the fluorescent green toner particles (2) are used instead of the fluorescent green toner particles (1).

### Preparation of Fluorescent Green Toner 3 and Developer 3

### Preparation of Release Agent Particle Dispersion Liquid (3)

Microcrystalline wax “HiMic-1070” produced by Nippon Seiro Co., Ltd. (melting temperature: 80° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (3) (solid content: 20% by mass), in which release agent particles having a volume average size of 200 nm are dispersed, is prepared.

### Preparation of Fluorescent Green Toner Particles (3)

Fluorescent green toner particles (3) are prepared as in the preparation of the fluorescent green toner particles (1), except that the release agent particle dispersion liquid (1) is changed to the release agent particle dispersion liquid (3). The volume average size of the fluorescent green toner particles (3) is 5.9 μm. The content of the granular material is 4% by mass of the total amount of the fluorescent green toner particles (3).

### Preparation of Toner and Developer

A fluorescent green toner 3 and a developer 3 are prepared as in the preparation of the fluorescent green toner 1 and the developer 1, respectively, except that the fluorescent green toner particles (3) are used instead of the fluorescent green toner particles (1).

### Preparation of Fluorescent Green Toner 4 and Developer 4

### Preparation of Colorant Particle Dispersion Liquid (3)

Fluorescent dye Solvent Green 3 (C. I. Solvent green 3 “OPLAS GREEN 533” produced by BASF SE: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a colorant particle dispersion liquid (3) is prepared.

### Preparation of Fluorescent Green Toner Particles (4)

Crystalline resin particle dispersion liquid (1): 35 parts
Amorphous resin particle dispersion liquid (1): 100 parts
Colorant particle dispersion liquid (1): 100 parts
Colorant particle dispersion liquid (3): 42 parts
Release agent particle dispersion liquid (1): 40 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 100 parts of the amorphous resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, fluorescent green toner particles (4) are prepared. The volume average size of the fluorescent green toner particles (4) is 5.7 μm. The content of the granular material is 0% by mass of the total amount of the fluorescent green toner particles (4).

### Preparation of Toner and Developer

A fluorescent green toner 4 and a developer 4 are prepared as in the preparation of the fluorescent green toner 1 and the developer 1, respectively, except that the fluorescent green toner particles (4) are used instead of the fluorescent green toner particles (1).

### Preparation of Fluorescent Pink Toner 5 and Developer 5

### Preparation of Colorant Particle Dispersion Liquid (4)

Fluorescent dye Basic Red 1:1 (C. I. Basic Red 1:1 “Basonyl Red 485”) produced by BASF SE: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a colorant particle dispersion liquid (4) is prepared.

### Preparation of Colorant Particle Dispersion Liquid (5)

Fluorescent dye Basic Violet 11:1 (C. I. Basic Violet 11:1 “Neeliglow Basic Violet 11:1”) produced by NEELIKON: 2 parts
Amorphous polyester resin (weight average molecular weight: 13,000, glass transition temperature: 62° C.): 100 parts

The above materials are mixed together while heated in order to blend the dye into the resin. The resulting kneaded material is rolled and then cooled to 30° C. or less. Subsequently, the kneaded material is coarsely crushed to 1 mm or less with a hammer mill and then pulverized with a jet mill “AFG” produced by Hosokawa Micron Corporation. The pulverized particles are mixed with 30 parts of an anionic surfactant “Neogen RK” produced by Dai-ichi Kogyo Seiyaku Co., Ltd. (solid content: 20%) and 200 parts of ion-exchange water. The resulting mixture is pulverized to a volume average particle size of 200 nm with Key Mill (continuous type) “KMC-3” produced by Inoue Mfg., Inc. The solid content in the resulting dispersion liquid is adjusted to 20% by mass. Hereby, a colorant particle dispersion liquid (5) is prepared.

### Preparation of Fluorescent Pink Toner Particles (5)

Crystalline resin particle dispersion liquid (1): 35 parts
Amorphous resin particle dispersion liquid (1): 100 parts
Colorant particle dispersion liquid (4): 71 parts
Colorant particle dispersion liquid (5): 71 parts
Release agent particle dispersion liquid (1): 40 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 100 parts of the amorphous resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, fluorescent pink toner particles (5) are prepared. The volume average size of the fluorescent pink toner particles (5) is 5.7 μm. The content of the granular material is 0% by mass of the total amount of the fluorescent pink toner particles (5).

### Preparation of Toner and Developer

A fluorescent pink toner 5 and a developer 5 are prepared as in the preparation of the fluorescent green toner 1 and the developer 1, respectively, except that the fluorescent pink toner particles (5) are used instead of the fluorescent green toner particles (1).

### Preparation of Fluorescent Pink Toner 6 and Developer 6

### Synthesis of Crystalline Resin Particle Dispersion Liquid (2)

1,10-Dodecanedioic acid: 50 mol %
1,2-Nonanediol: 50 mol %

The above monomer components are charged into a reactor equipped with a stirrer, a thermometer, a condenser, and a nitrogen gas introduction tube. After the inside of the reactor has been purged with a dry nitrogen gas, 0.25 parts of titanium tetrabutoxide (i.e., a reagent) relative to 100 parts of the monomer components is charged into the reactor. The resulting mixture is stirred for 3 hours at 170° C. under a nitrogen gas stream to cause a reaction. Subsequently, the temperature is increased to 210° C. over 1 hour and the pressure inside the reactor is reduced to 3 kPa. Then, a reaction is conducted for 13 hours under reduced pressure while stirring is performed. Hereby, a crystalline polyester resin (2) is prepared.

The melting temperature of the crystalline polyester resin (2) determined by DSC is 85.3° C. The mass average molecular weight Mw of the crystalline polyester resin (2) determined by GPC is 24,000. The number average molecular weight Mn of the crystalline polyester resin (2) is 10,800. The acid value AV of the crystalline polyester resin (2) is 11.1 mgKOH/g.

Into a jacketed reaction vessel (“BJ-30N” produced by TOKYO RIKAKIKAI CO, LTD.) equipped with a condenser, a thermometer, a water dropper, and an anchor impeller, 300 parts of the crystalline polyester resin (1), 160 parts of methyl ethyl ketone (i.e., a solvent), and 100 parts of isopropyl alcohol (i.e., a solvent) are charged. While the temperature is maintained at 70° C. with a water circulation thermostat, the resin is dissolved by performing stirring at 100 rpm.

Then, the rotation speed at which stirring is performed is changed to 150 rpm, and the temperature of the water circulation thermostat is set to 66° C. Subsequently, 17 parts of a 10-mass % ammonia water (i.e., a reagent) is charged into the vessel over 10 minutes, and 900 parts of ion-exchange water maintained at 66° C. is added dropwise to the vessel at a rate of 7 part/min in total in order to perform phase inversion. Hereby, an emulsion is prepared.

Immediately after this, 800 parts of the emulsion and 700 parts of ion-exchange water are charged into an eggplant flask, which is connected to an evaporator (produced by (TOKYO RIKAKIKAI CO, LTD.) equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. When the amount of the solvent collected reaches 1,100 parts, the pressure is increased to normal pressure and the eggplant flask is cooled with water. Hereby, a dispersion liquid is prepared. The dispersion liquid does not have an odor of the solvent. The volume average size of the resin particles included in the dispersion liquid is 130 nm. Ion-exchange water is added to the dispersion liquid in order to adjust the solid content in the dispersion liquid to 20%. Hereby, a crystalline resin particle dispersion liquid (2) is prepared.

### Preparation of Fluorescent Pink Toner Particles (6)

Fluorescent pink toner particles (6) are prepared as in the preparation of the fluorescent pink toner particles (5), except that the crystalline resin particle dispersion liquid (1) is changed to the crystalline resin particle dispersion liquid (2). The volume average size of the fluorescent pink toner particles (6) is 5.9 μm. The content of the granular material is 0% by mass of the total amount of the fluorescent pink toner particles (6).

### Preparation of Toner and Developer

A fluorescent pink toner 6 and a developer 6 are prepared as in the preparation of the fluorescent pink toner 5 and the developer 5, respectively, except that the fluorescent pink toner particles (6) are used instead of the fluorescent pink toner particles (5).

### Preparation of Fluorescent Pink Toner 7 and Developer 7

### Preparation of Release Agent Particle Dispersion Liquid (4)

Paraffin wax “Parafin Wax-140” produced by Nippon Seiro Co., Ltd. (melting temperature: 61° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (4) (solid content: 20% by mass), in which release agent particles having a volume average size of 200 nm are dispersed, is prepared.

### Preparation of Fluorescent Pink Toner Particles (7)

Fluorescent pink toner particles (7) are prepared as in the preparation of the fluorescent pink toner particles (5), except that the release agent particle dispersion liquid (1) is changed to the release agent particle dispersion liquid (4). The volume average size of the fluorescent pink toner particles (7) is 5.8 μm. The content of the granular material is 0% by mass of the total amount of the fluorescent pink toner particles (7).

### Preparation of Toner and Developer

A fluorescent pink toner 7 and a developer 7 are prepared as in the preparation of the fluorescent pink toner 5 and the developer 5, respectively, except that the fluorescent pink toner particles (7) are used instead of the fluorescent pink toner particles (5).

### Preparation of Fluorescent Pink Toner 8 and Developer 8

### Preparation of Colorant Particle Dispersion Liquid (6)

Nonfluorescent pigment PR122 (C. I. Pigment Red 122 “FASTOGEN SUPER MAGENTA R” produced by DIC corporation, volume average particle size: 100 nm): 70 parts
Anionic surfactant “Neogen RK” produced by Dai-ichi Kogyo Seiyaku Co., Ltd.: 30 parts
Ion-exchange water: 200 parts

The above components are mixed together, and the resulting mixture is pulverized to 90 nm with Key Mill (continuous type) “KMC-3”. The solid content in the resulting dispersion liquid is adjusted to 20% by mass. Hereby, a colorant particle dispersion liquid (6) is prepared.

### Preparation of Fluorescent Pink Toner Particles (8)

Crystalline resin particle dispersion liquid (1): 35 parts
Amorphous resin particle dispersion liquid (1): 100 parts
Colorant particle dispersion liquid (4): 125 parts
Colorant particle dispersion liquid (6): 17 parts
Release agent particle dispersion liquid (1): 40 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 100 parts of the amorphous resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, fluorescent pink toner particles (8) are prepared. The volume average size of the fluorescent pink toner particles (8) is 5.7 μm. The content of the granular material is 4% by mass of the total amount of the fluorescent pink toner particles (8).

### Preparation of Toner and Developer

A fluorescent pink toner 8 and a developer 8 are prepared as in the preparation of the fluorescent pink toner 5 and the developer 5, respectively, except that the fluorescent pink toner particles (8) are used instead of the fluorescent pink toner particles (5).

### Preparation of Transparent Toner 9 and Developer 9

### Preparation of Inorganic Particle Dispersion Liquid (1)

Silica particles (“X-24-9404” produced by Shin-Etsu Chemical Co., Ltd., volume average particle size: 50 nm): 70 parts
Anionic surfactant (“NEOGEN RK” produced by Dai-ichi Kogyo Seiyaku Co., Ltd.): 30 parts
Ion-exchange water: 200 parts

The above materials are mixed together, and the resulting mixture is dispersed with a homogenizer “ULTRA-TURRAX T50” produced by IKA for 10 minutes. Ion-exchange water is added to the resulting dispersion liquid such that the solid content in the dispersion liquid reaches 20% by mass. Hereby, an inorganic particle dispersion liquid (1) having a volume average particle size of 50 nm is prepared.

### Preparation of Transparent Toner Particles (9)

Crystalline resin particle dispersion liquid (1): 35 parts
Amorphous resin particle dispersion liquid (1): 225 parts
Inorganic particle dispersion liquid (1): 17 parts
Release agent particle dispersion liquid (1): 40 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 100 parts of the amorphous resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, transparent toner particles (9) are prepared. The volume average size of the transparent toner particles (9) is 5.7 μm. The content of the granular material is 4% by mass of the total amount of the transparent toner particles (9).

### Preparation of Toner and Developer

A transparent toner 9 and a developer 9 are prepared as in the preparation of the fluorescent green toner 1 and the developer 1, respectively, except that the transparent toner particles (9) are used instead of the fluorescent green toner particles (1).

### Preparation of Transparent Toner 10 and Developer 10

Transparent toner particles (10) are prepared as in the preparation of the transparent toner particles (9), except that the inorganic particle dispersion liquid (1) is not used. The volume average size of the transparent toner particles (10) is 5.8 μm. The content of the granular material is 0% by mass of the total amount of the transparent toner particles (10).

A transparent toner 10 and a developer 10 are prepared as in the preparation of the transparent toner 9 and the developer 9, respectively, except that the transparent toner particles (10) are used instead of the transparent toner particles (9).

### Preparation of Release Agent Particle Dispersion Liquid (5)

Microcrystalline wax “FT95” produced by Nippon Seiro Co., Ltd. (melting temperature: 98° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (5) (solid content: 20% by mass), in which release agent particles having a volume average size of 200 nm are dispersed, is prepared.

### Preparation of Release Agent Particle Dispersion Liquid (6)

Microcrystalline wax “Paraffin Wax-130” produced by Nippon Seiro Co., Ltd. (melting temperature: 56° C.): 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (6) (solid content: 20% by mass), in which release agent particles having a volume average size of 200 nm are dispersed, is prepared.

### Preparation of Fluorescent Green Toner Particles (5)

Fluorescent green toner particles (5) are prepared as in the preparation of the fluorescent green toner particles (2), except that the release agent particle dispersion liquid (2) is changed to the release agent particle dispersion liquid (5). The volume average size of the fluorescent green toner particles (5) is 5.9 μm. The content of the granular material is 4% by mass of the total amount of the fluorescent green toner particles (5).

### Preparation of Toner and Developer

A fluorescent green toner 5 and a developer 11 are prepared as in the preparation of the fluorescent green toner 2 and the developer 2, respectively, except that the fluorescent green toner particles (5) are used instead of the fluorescent green toner particles (2).

### Preparation of Fluorescent Green Toner Particles (6)

Fluorescent green toner particles (6) are prepared as in the preparation of the fluorescent green toner particles (2), except that the release agent particle dispersion liquid (2) is changed to the release agent particle dispersion liquid (6). The volume average size of the fluorescent green toner particles (6) is 5.9 μm. The content of the granular material is 4% by mass of the total amount of the fluorescent green toner particles (6).

### Preparation of Toner and Developer

A fluorescent green toner 6 and a developer 12 are prepared as in the preparation of the fluorescent green toner 2 and the developer 2, respectively, except that the fluorescent green toner particles (6) are used instead of the fluorescent green toner particles (2).

### Examples 1 to 8 and Comparative Examples 1 to 4

Toners and developers prepared as described above are used in combination as described in Table 1 to form toner sets.

The YMCK toners used are commercial YMCK toners.

Table 1 lists the crystallization temperatures T1, T2, and T3, the difference between the crystallization temperatures T1 and T2 (in Table 1, “T1−T2(° C.)”), the difference between the crystallization temperatures T1 and T3 (in Table 1, “|T3−T1|(° C.)”), and the difference between the crystallization temperatures T2 and T3 (in Table 1, “|T3−T2|(° C.)”) of each of the toners which are determined by the above-described methods.

### Evaluations

### Image Forming Apparatus

In the image forming apparatus illustrated in FIG. 1, the developer A listed in Table 1 is fed to the developing device 4G of the first image formation unit 10G, the developer B listed in Table 1 is fed to the developing device 4P of the second image formation unit 10P, and the YMCK developers are fed to the developing devices 4Y, 4M, 4C, and 4K of the yellow, magenta, cyan, and black image formation units 10Y, 10M, 10C, and 10K, respectively. Moreover, a modification is made such that the fusing temperature of the fixing device 28 can be changed. An image is formed using the above image forming apparatus. The processing speed is 534 mm/sec.

### Evaluation of Hot Offset

An unfixed image that is a multilayer of six colors of 50 mm×50 mm solid images having an area coverage of 100% is formed using sheets of thin quality paper (“NPI Quality” paper, 52 g/m², produced by Nippon Paper Industries Co., Ltd.) as recording media such that the toner deposition density is 20 g/m² in total.

The unfixed image is fixed to the recording media while the fusing temperature is changed from 170° C. to 230° C. at intervals of 5° C., and the occurrence of hot offset is visually confirmed. The minimum temperature at which hot offset occurs is determined as a hot offset-occurring temperature. The evaluation standard used is as described below. Table 1 lists the results.
A: Hot offset-occurring temperature is 230° C. or more.
B: Hot offset-occurring temperature is 210° C. or more and less than 230° C.
C: Hot offset-occurring temperature is 190° C. or more and less than 210° C.
D: Hot offset-occurring temperature is less than 190° C.

### Evaluation of Cold Offset

An unfixed image that is a multilayer of six colors of 50 mm×50 mm solid images having an area coverage of 100% is formed using sheets of thick coat paper (“AURORA COAT” paper, 209 g/m², produced by Nippon Paper Industries Co., Ltd.) as recording media such that the toner deposition density is 20 g/m² in total.

The unfixed image is fixed to the recording media while the fusing temperature is changed from 150° C. to 200° C. at intervals of 5° C., and the occurrence of cold offset is visually confirmed. The minimum temperature at which cold offset occurs is determined as a cold offset-occurring temperature. The evaluation standard used is as described below. Table 1 lists the results.
A: Cold offset-occurring temperature is 150° C. or less.
B: Cold offset-occurring temperature is more than 150° C. and 160° C. or less.
C: Cold offset-occurring temperature is more than 160° C. and 170° C. or less.
D: Cold offset-occurring temperature is more than 170° C.

TABLE 1

| | | | | | YMCK | | | | | |
|---|---|---|---|---|---|---|---|---|---|---|
| | Developer A | | Developer B | | developer | | | | | |
| | | Crystallization | | Crystallization | Crystallization | | | | | |
| | | temperature | | temperature | temperature | | | | Evaluation | |
| | | T1 | | T2 | T3 | T1 − T2 | \|T3 − T1\| | \|T3 − T2\| | Hot | Cold |
| | No. | (° C.) | No. | (° C.) | (° C.) | (° C.) | (° C.) | (° C.) | offset | offset |
| Example 1 | 1 | 87 | 5 | 68 | 89 | 19 | 2 | 21 | B | A |
| Example 2 | 2 | 94 | 7 | 61 | 89 | 33 | 5 | 28 | A | A |
| Example 3 | 3 | 80 | 6 | 75 | 89 | 5 | 9 | 14 | A | B |
| Example 4 | 4 | 68 | 8 | 87 | 89 | 19 | 2 | 21 | B | B |
| Example 5 | 9 | 87 | 5 | 68 | 89 | 19 | 2 | 21 | B | A |
| Example 6 | 10 | 68 | 1 | 87 | 89 | 19 | 2 | 21 | B | B |
| Example 7 | 2 | 94 | 6 | 75 | 89 | 19 | 5 | 14 | A | C |
| Example 8 | 3 | 80 | 7 | 61 | 89 | 19 | 9 | 28 | C | A |
| Comparative | 4 | 68 | 5 | 68 | 89 | 0 | 21 | 21 | D | A |
| Example 1 | | | | | | | | | | |
| Comparative | 1 | 87 | 8 | 87 | 89 | 0 | 2 | 2 | A | D |
| Example 2 | | | | | | | | | | |
| Comparative | 11 | 98 | 5 | 68 | 89 | 30 | 9 | 21 | A | D |
| Example 3 | | | | | | | | | | |
| Comparative | 1 | 87 | 12 | 56 | 89 | 31 | 2 | 33 | D | A |
| Example 4 | | | | | | | | | | |

The results listed in Table 1 confirm that the toner sets prepared in Examples reduce the occurrence of both hot offset and cold offset.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrostatic image developing toner set including:
a yellow toner including a yellow pigment;
a magenta toner including a magenta pigment;
a cyan toner including a cyan pigment;
a black toner including a black pigment;
a first toner, the first toner being a dye toner or a transparent toner, the first toner having a crystallization temperature T1 of 80° C. or more and 95° C. or less; and
a second toner, the second toner being a dye toner or a transparent toner, the second toner having a crystallization temperature T2 of 60° C. or more and 75° C. or less.

(((2))) The electrostatic image developing toner set according to (((1))), wherein a difference between the crystallization temperatures T1 and T2 is 15° C. or more.

(((3))) The electrostatic image developing toner set according to (((2))), wherein the difference between the crystallization temperatures T1 and T2 is 20° C. or more.

(((4))) The electrostatic image developing toner set according to any one of (((1))) to (((3))),
wherein, when an average of a crystallization temperature of the yellow toner, a crystallization temperature of the magenta toner, a crystallization temperature of the cyan toner, and a crystallization temperature of the black toner is defined as a crystallization temperature T3,
a difference between the crystallization temperatures T1 and T3 is 5° C. or less, and
a difference between the crystallization temperatures T2 and T3 is 20° C. or more.

(((5))) The electrostatic image developing toner set according to any one of (((1))) to (((4))),
wherein the first toner includes first toner particles, the first toner particles including a crystalline resin and a granular material, and
the second toner includes second toner particles including a crystalline resin.

(((6))) The electrostatic image developing toner set according to (((5))),
wherein the granular material is colorless and transparent.

(((7))) The electrostatic image developing toner set according to (((5))) or (((6))),
wherein the granular material is silica particles.

(((8))) The electrostatic image developing toner set according to any one of (((5))) to (((7))),
wherein a content of the granular material in the first toner is 1% by mass or more and 5% by mass or less.

((9))) An electrostatic image developer set including:
a yellow developer, a magenta developer, a cyan developer, and a black developer including the yellow, magenta, cyan, and black toners included in the electrostatic image developing toner set according to any one of (((1))) to (((8))), respectively;
a first developer including the first toner included in the electrostatic image developing toner set according to any one of (((1))) to (((8))); and
a second developer including the second toner included in the electrostatic image developing toner set according to any one of (((1))) to (((8))).

(((10))) A toner cartridge set detachably attachable to an image forming apparatus, the toner cartridge set including:
a yellow toner cartridge, a magenta toner cartridge, a cyan toner cartridge, and a black toner cartridge including the yellow, magenta, cyan, and black toners included in the electrostatic image developing toner set according to any one of (((1))) to (((8))), respectively;
a first toner cartridge including the first toner included in the electrostatic image developing toner set according to any one of (((1))) to (((8))); and
a second toner cartridge including the second toner included in the electrostatic image developing toner set according to any one of (((1))) to (((8))).

(((11))) A process cartridge detachably attachable to an image forming apparatus, the process cartridge including:
a yellow developing unit, a magenta developing unit, a cyan developing unit, and a black developing unit including the yellow, magenta, cyan, and black developers included in the electrostatic image developer set according to (((9))), respectively;
a first developing unit including the first developer included in the electrostatic image developer set according to (((9))); and
a second developing unit including the second developer included in the electrostatic image developer set according to (((9))).

(((12))) An image forming apparatus including:
yellow, magenta, cyan, and black image formation units that form yellow, magenta, cyan, and black images using the yellow, magenta, cyan, and black toners included in the electrostatic image developing toner set according to any one of (((1))) to (((8))), respectively;
a first image formation unit that forms a first image using the first toner included in the electrostatic image developing toner set according to any one of (((1))) to (((8)));
a second image formation unit that forms a second image using the second toner included in the electrostatic image developing toner set according to any one of (((1))) to (((8)));
a transfer unit that transfers the yellow, magenta, cyan, black, first, and second images to a recording medium; and
a fixing unit that fixes a toner image to the recording medium, the toner image including the yellow, magenta, cyan, black, first, and second images stacked on top of one another.

(((13))) The image forming apparatus according to (((12))),
wherein, among layers constituting the toner image, a layer farthest from the recording medium is the first image and a layer second farthest from the recording medium is the second image.

(((14))) An image forming method including:
yellow, magenta, cyan, and black image formation steps of forming yellow, magenta, cyan, and black images using the yellow, magenta, cyan, and black toners included in the electrostatic image developing toner set according to any one of (((1))) to (((8))), respectively;
a first image formation step of forming a first image using the first toner included in the electrostatic image developing toner set according to any one of (((1))) to (((8)));
a second image formation step of forming a second image using the second toner included in the electrostatic image developing toner set according to any one of (((1))) to (((8)));
a transfer step of transferring the yellow, magenta, cyan, black, first, and second images to a recording medium; and
a fixing step of fixing a toner image to the recording medium, the toner image including the yellow, magenta, cyan, black, first, and second images stacked on top of one another.

(((15))) The image forming method according to (((14))),
wherein, among layers constituting the toner image, a layer farthest from the recording medium is the first image and a layer second farthest from the recording medium is the second image.

What is claimed is:

1. An electrostatic image developing toner set comprising:
a yellow toner including a yellow pigment;
a magenta toner including a magenta pigment;
a cyan toner including a cyan pigment;
a black toner including a black pigment;
a first toner, the first toner being a dye toner or a transparent toner, the first toner having a crystallization temperature T1 of 80° C. or more and 95° C. or less; and
a second toner, the second toner being a dye toner or a transparent toner, the second toner having a crystallization temperature T2 of 60° C. or more and 75° C. or less.

2. The electrostatic image developing toner set according to claim 1,
wherein a difference between the crystallization temperatures T1 and T2 is 15° C. or more.

3. The electrostatic image developing toner set according to claim 2,
wherein the difference between the crystallization temperatures T1 and T2 is 20° C. or more.

4. The electrostatic image developing toner set according to claim 1,
wherein, when an average of a crystallization temperature of the yellow toner, a crystallization temperature of the magenta toner, a crystallization temperature of the cyan toner, and a crystallization temperature of the black toner is defined as a crystallization temperature T3,
a difference between the crystallization temperatures T1 and T3 is 5° C. or less, and
a difference between the crystallization temperatures T2 and T3 is 20° C. or more.

5. The electrostatic image developing toner set according to claim 1,
wherein the first toner includes first toner particles, the first toner particles including a crystalline resin and a granular material, and
the second toner includes second toner particles including a crystalline resin.

6. The electrostatic image developing toner set according to claim 5,
wherein the granular material is colorless and transparent.

7. The electrostatic image developing toner set according to claim 5,
wherein the granular material is silica particles.

8. The electrostatic image developing toner set according to claim 5,
wherein a content of the granular material in the first toner is 1% by mass or more and 5% by mass or less.

9. An electrostatic image developer set comprising:
a yellow developer, a magenta developer, a cyan developer, and a black developer including the yellow, magenta, cyan, and black toners included in the electrostatic image developing toner set according to claim 1, respectively;
a first developer including the first toner included in the electrostatic image developing toner set according to claim 1; and
a second developer including the second toner included in the electrostatic image developing toner set according to claim 1.

10. An electrostatic image developer set comprising:
a yellow developer, a magenta developer, a cyan developer, and a black developer including the yellow, magenta, cyan, and black toners included in the electrostatic image developing toner set according to claim 2, respectively;
a first developer including the first toner included in the electrostatic image developing toner set according to claim 2; and
a second developer including the second toner included in the electrostatic image developing toner set according to claim 2.

11. An electrostatic image developer set comprising:
a yellow developer, a magenta developer, a cyan developer, and a black developer including the yellow, magenta, cyan, and black toners included in the electrostatic image developing toner set according to claim 3, respectively;
a first developer including the first toner included in the electrostatic image developing toner set according to claim 3; and
a second developer including the second toner included in the electrostatic image developing toner set according to claim 3.

12. An electrostatic image developer set comprising:
a yellow developer, a magenta developer, a cyan developer, and a black developer including the yellow, magenta, cyan, and black toners included in the electrostatic image developing toner set according to claim 4, respectively;
a first developer including the first toner included in the electrostatic image developing toner set according to claim 4; and
a second developer including the second toner included in the electrostatic image developing toner set according to claim 4.

13. An electrostatic image developer set comprising:
a yellow developer, a magenta developer, a cyan developer, and a black developer including the yellow, magenta, cyan, and black toners included in the electrostatic image developing toner set according to claim 5, respectively;
a first developer including the first toner included in the electrostatic image developing toner set according to claim 5; and
a second developer including the second toner included in the electrostatic image developing toner set according to claim 5.

14. An electrostatic image developer set comprising:
a yellow developer, a magenta developer, a cyan developer, and a black developer including the yellow, magenta, cyan, and black toners included in the electrostatic image developing toner set according to claim 6, respectively;
a first developer including the first toner included in the electrostatic image developing toner set according to claim 6; and
a second developer including the second toner included in the electrostatic image developing toner set according to claim 6.

15. A toner cartridge set detachably attachable to an image forming apparatus, the toner cartridge set comprising:
a yellow toner cartridge, a magenta toner cartridge, a cyan toner cartridge, and a black toner cartridge including the yellow, magenta, cyan, and black toners included in the electrostatic image developing toner set according to claim 1, respectively;
a first toner cartridge including the first toner included in the electrostatic image developing toner set according to claim 1; and
a second toner cartridge including the second toner included in the electrostatic image developing toner set according to claim 1.

16. A process cartridge detachably attachable to an image forming apparatus, the process cartridge comprising:
a yellow developing unit, a magenta developing unit, a cyan developing unit, and a black developing unit including the yellow, magenta, cyan, and black developers included in the electrostatic image developer set according to claim 9, respectively;
a first developing unit including the first developer included in the electrostatic image developer set according to claim 9; and
a second developing unit including the second developer included in the electrostatic image developer set according to claim 9.

17. An image forming apparatus comprising:
yellow, magenta, cyan, and black image formation units that form yellow, magenta, cyan, and black images using the yellow, magenta, cyan, and black toners included in the electrostatic image developing toner set according to claim 1, respectively;
a first image formation unit that forms a first image using the first toner included in the electrostatic image developing toner set according to claim 1;
a second image formation unit that forms a second image using the second toner included in the electrostatic image developing toner set according to claim 1;
a transfer unit that transfers the yellow, magenta, cyan, black, first, and second images to a recording medium; and
a fixing unit that fixes a toner image to the recording medium, the toner image including the yellow, magenta, cyan, black, first, and second images stacked on top of one another.

18. The image forming apparatus according to claim 17,
wherein, among layers constituting the toner image, a layer farthest from the recording medium is the first image and a layer second farthest from the recording medium is the second image.

19. An image forming method comprising:
yellow, magenta, cyan, and black image formation steps of forming yellow, magenta, cyan, and black images using the yellow, magenta, cyan, and black toners included in the electrostatic image developing toner set according to claim 1, respectively;
a first image formation step of forming a first image using the first toner included in the electrostatic image developing toner set according to claim 1;
a second image formation step of forming a second image using the second toner included in the electrostatic image developing toner set according to claim 1;
a transfer step of transferring the yellow, magenta, cyan, black, first, and second images to a recording medium; and
a fixing step of fixing a toner image to the recording medium, the toner image including the yellow, magenta, cyan, black, first, and second images stacked on top of one another.

20. The image forming method according to claim 19,
wherein, among layers constituting the toner image, a layer farthest from the recording medium is the first image and a layer second farthest from the recording medium is the second image.
